(19) United States
(12) Patent Application Publication
(10) Pub. No.: US 2014/0218173 A1
(43) Pub. Date: Aug. 7, 2014

(54) SYSTEM AND METHOD FOR DETECTING AND IDENTIFYING DEVICE UTILIZATION

(71) Applicants: Avery Dallas Long, Madison, AL (US); Harvey A Nix, Birmingham, AL (US); Rome Maurice Burtis, Birmingham, AL (US)

(72) Inventors: Avery Dallas Long, Madison, AL (US); Harvey A Nix, Birmingham, AL (US); Rome Maurice Burtis, Birmingham, AL (US)

(21) Appl. No.: 14/240,271

(22) PCT Filed: Aug. 29, 2012
(86) PCT No.: PCT/US12/52901

§ 371 Date: Feb. 21, 2014

Related U.S. Application Data
(60) Provisional application No. 61/575,848, filed on Aug. 30, 2011.

(51) Int. Cl. G06K 7/10

(52) U.S. Cl. CPC G06K 7/10366
USPC 340/10.1

(57) ABSTRACT

A control unit associated with a monitored device, wherein the control unit has a tag radio and a main radio. The tag radio has a first antenna operable to detect and communicate with a wearable tag associated with an asset, such as a person, a piece of equipment, or a supply, over a first communications channel. The main radio has a second antenna operable to communicate data over a second communications channel. In a preferred embodiment, the control unit is operable to communicate simultaneously with a wearable tag and with a communications network using the tag radio and the main radio, respectively. Further, the tag radio is operable to determine actions of a person associated with a wearable tag based upon Radio Signal Strength Identification (RSSI) values detected in short-range communications from the wearable tag.

### PRIORITY CLAIM

This application claims priority to and the benefit of United States provisional patent application No. 61/575,848, filed 30 Aug. 2011.

### TECHNICAL FIELD

The present disclosure relates to a system operable to detect and identify proximity to and use of a monitored device by a plurality of tagged assets.

### BACKGROUND ART

In many industries, it is desirable to implement communications systems to monitor and identify a tagged asset's proximity to or use of a monitored device. For example, healthcare facilities routinely seek systems capable of monitoring and identifying tagged assets (that is, hospital employees having a wearable tag) use of hand hygiene dispensers. While wireless communications systems attempt to meet this need, they are subject to inefficiencies in terms of detecting and identifying tagged assets' use of monitored devices in a uniform manner. Within the context of wireless communications, it is well known that transmitting data wirelessly poses significant challenges which must be addressed before robust and reliable communications may be achieved. One challenge, which is relevant to the present disclosure, relates to the noticeable decrease in system accuracy resulting from assigning both short range and long range communications functions to an individual node or connection point in the wireless communications system.

As an example of the challenge mentioned above, current wireless communications systems employing Radio Frequency Identification (RFID) technology require a single RF radio of a microcontroller not only detect use of a monitored device by a tagged asset but also relay data relating to use of the monitored device to a server. This amounts to the RF radio handling both short range communications (that is, communications broadcast by tagged assets in proximity to the monitored device) as well as long range communications involving the server. With system resources available to a RF radio already limited by its RF engine, the RF radio cannot detect a short range communication from a tagged asset using the monitored device while simultaneously transmitting a long range communication to the server. Accordingly, results relating to use of a monitored device may not represent an accurate measure of the frequency with which the device is used. Furthermore, since the RF radio, tagged assets, and server are confined to communicating on the same channel, the accuracy of results relating to use will decrease as the number of tagged assets increase due to an increase in probability of the RF radio missing short range communications from tagged assets.

Another challenge, which stems from having a single RF radio handle short and long range communications, concerns power consumption of wearable RFID tags affixed to tagged assets. Having one RF radio per monitored device means RFID tags must listen for network traffic prior to communicating with the RF radio to avoid data collisions. This causes RFID tags to stay on longer, consuming more power per communication, which over time reduces the battery life of the wearable RFID tags. Therefore, there is a need for a wireless communications system employing RFID technology which overcomes these shortcomings.

### DISCLOSURE OF THE INVENTION

Embodiments of the present disclosure provide a system for detecting and identifying use of a monitored device. The system includes a wearable tag, a control unit, a feedback device, and a server in communication with the control unit over a network. The wearable tag, which is preferably in the form of an RFID badge, may be detected by a control unit in proximity to a monitored device. Upon detecting the presence of the wearable tag in relation to the monitored device, the control unit communicates data concerning the wearable tag to the server through the network. After receiving data, the server processes and records it in a database. The server is also operable, through the feedback device, to communicate items of interest relevant to the wearable tag and based at least in part upon data relating to the wearable tag.

In an exemplary embodiment, the system is operable to detect and identify use of a hand hygiene dispenser located in a healthcare facility. A control unit, which is in proximity to the hand hygiene dispenser, is operable to detect a wearable tag worn by an employee or visitor's use of or proximity to the dispenser. The control unit further includes two microcontrollers with integrated RF transceivers whereby one of the microcontrollers, hereinafter referred to as a tag radio, detects short-range wireless communications involving a wearable tag in proximity to a monitored device. The remaining microcontroller, hereinafter referred to as a main radio, processes long-range wireless communications over the network. Furthermore, the tag radio and main radio are operable to communicate on separate channels from each another, which allows for parallel processing and optimizes the accuracy of the system.

More specifically, in an exemplary embodiment, the tag radio further includes a patch antenna operable to detect short-range wireless communications involving a wearable tag and identify data comprising a unique identification code and a Radio Signal Strength Identification (RSSI) value associated with the wearable tag. Once the patch antenna collects data, the tag radio compares the RSSI value against a plurality of RSSI threshold values to determine whether the RSSI value of the wearable tag equals or exceeds any of those threshold values. For example, a tag radio may have a threshold value for monitoring a wearable tag's entry/exit of a room or area having a monitored device in addition to a threshold value for monitoring use of the device. Once the tag radio determines an RSSI value of a wearable tag equals or exceeds any of its threshold values, data relating to at least the unique identification code is communicated to the main radio.

In yet another embodiment, the main radio further includes a planar inverted F antenna (PIFA antenna) operable to transmit and detect long-range wireless communications over the network. Accordingly, the PIFA antenna of the main radio may communicate data relating to the wearable tag. The PIFA antenna may also receive communications from the server containing items of interest to a wearable tag. Upon receiving communications containing items of interest, the main radio is operable to communicate items of interest to the feedback device.

In one embodiment, the network may include a network bridge operable to receive and transmit long-range wireless communications involving the main radio. In a preferred embodiment, the network bridge translates long-range wireless communications from the main radio to TCP/IP format and communicates the data to the server. Still further, in another embodiment, the network bridge may have a database similar to the server and communicates items of interest from the database minimizing the amount of time it takes to display information on the feedback device.

These and other embodiments of the present disclosure will become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 is a schematic representation of one embodiment of a system for detecting and identifying device utilization.

FIG. 1A is a more detailed representation of a control unit shown in FIG. 1.

FIG. 2 is a flowchart illustrating the functionality of the tag radio shown in FIG. 1.

FIG. 3 is a flowchart illustrating the functionality of the main radio shown in FIG. 1.

FIG. 4 is a flowchart illustrating the functionality of the wearable tag shown in FIG. 1.

### BEST MODE FOR CARRYING OUT INVENTION

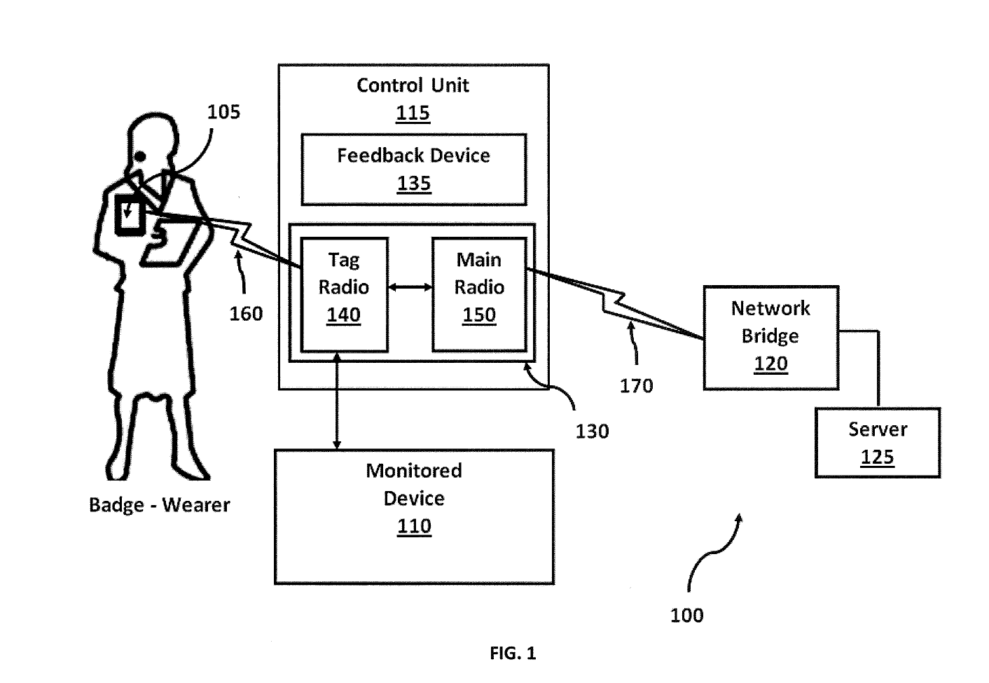

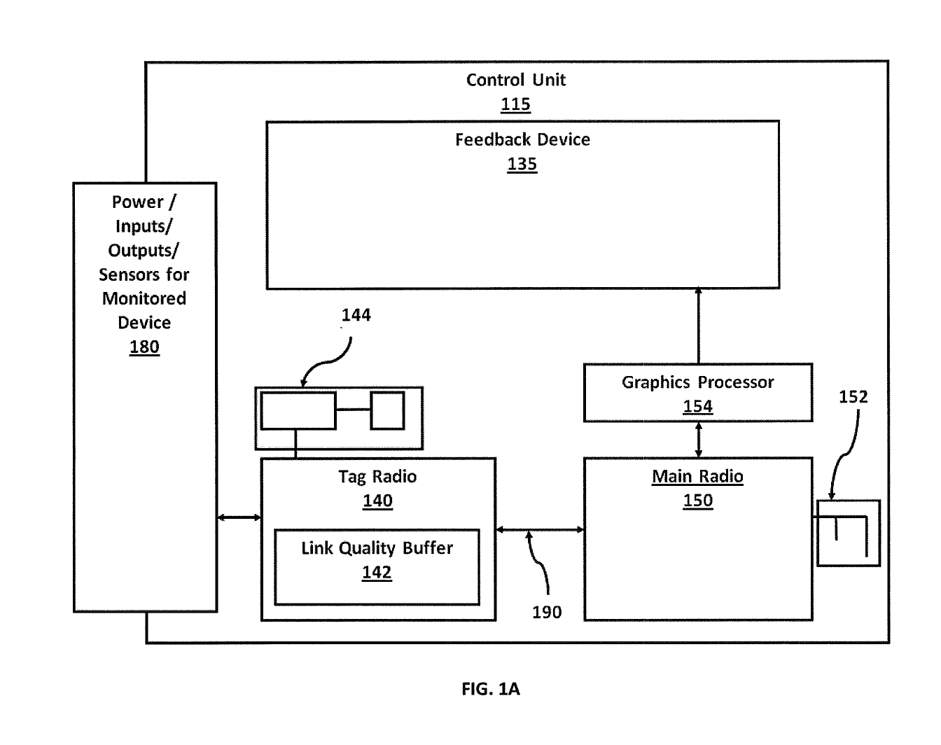

The various embodiments of the present invention and their advantages may be better understood by referring to FIGS. 1 through 4 of the drawings. The elements of the drawings are not necessarily to scale, emphasis instead being placed upon illustrating the principles of preferred embodiments of the present invention. Throughout the drawings, like numerals are used for like and corresponding parts of the various drawings. This invention may be provided in other specific forms and embodiments without departing from the essential characteristics as described herein. The embodiments described below are to be considered in all aspects as illustrative only and not restrictive in any manner.

The present disclosure relates to a system operable to monitor and identify utilization of a monitored device, the system comprising a wearable tag, a control unit, a feedback device, and a server in communication with the control unit over a communications network. The wearable tag, which in a preferred embodiment is in the form of a plurality of RFID badges, may be associated with an asset, such as a person, a piece of equipment, or a supply. As described in more detail below, the wearable tag transmits a low range signal at regular intervals upon detecting movement or after a predetermined interval of time. The control unit is operable to detect and identify the wearable tag within a predetermined proximity of the control unit and communicate data concerning the wearable tag to the server via the network. After the server analyzes data, the server communicates to the feedback device in proximity to the control unit items of interest to an individual user associated with the wearable tag based at least in part upon the data collected by the control unit.

Referring now to FIG. 1, one embodiment of a system (100) for tracking device usage is shown comprising a wearable tag (105), a monitored device (110), a control unit (115), a communications network comprising a network bridge (120), and a server (125). In an exemplary embodiment, the wearable tag (105) is associated with a healthcare employee with the monitored device (120) being a hand hygiene dispenser. The control unit (115) further includes a plurality of microcontrollers (130) having integrated RF transceivers and a feedback device (135). More specifically, one of the microcontrollers (130) is hereinafter referred to as a tag radio (140) and is operable to process short range wireless communications (160) involving a wearable tag (105) in proximity to the monitored device (110). Likewise, another microcontroller (130) is hereinafter referred to as a main radio (150) and is operable to processes long range wireless communications (170) involving the network bridge (120). The feedback device (135) is operable to display items of interest to the healthcare employee based at least in part upon data relating to the wearable tag (105) that the server (125) receives via the network bridge (120). The network bridge (120) may be any communications bridge, hub, router, node, or other unit known in the art for transferring information over a network, in any network topology or architecture. In one embodiment, the main radio (150) is operable to communicate directly to a receiver communicatively coupled to the server (125).

Turning to FIG. 1A in conjunction with FIG. 1, the tag radio (140) further includes a patch antenna (142) and a link quality buffer (144). The patch antenna (142) detects short range wireless communications (160) originating from a wearable tag (105) within a predetermined proximity to a monitored device (110). In an exemplary embodiment, the patch antenna (142) is operable to detect a wearable tag (105) entering rooms in which the monitored device (110) is located. Accordingly, the patch antenna (142) is operable to detect a hospital employee having a wearable tag (105) entering a room containing a hand hygiene dispenser or other like monitored device (110). Once the patch antenna (144) detects a short range wireless communication (160), the tag radio (140) analyzes the Radio Signal Strength Identification (RSSI) value of the short range wireless communication (160). If the RSSI value equals or exceeds a predetermined threshold value for the monitored device (110), the tag radio (140) prompts the link quality buffer (144) to store the RSSI value. Still further, the tag radio (140) is also operable to track device usage by monitoring inputs (180) associated with a monitored device (110).

Referring further to FIG. 1A in conjunction with FIG. 1, in a preferred embodiment, the main radio (150) further includes a Planar Inverted F Antenna, hereinafter referred to as a PIFA antenna (152). In this embodiment, the main radio (150) receives data relating to a wearable tag (105) through a wired communication (190) with the tag radio (140). Upon receiving data, the main radio (150) transmits a long range wireless communication (170) to the network bridge (120) via the PIFA antenna (152). The network bridge (120) then transmits data to the server (125) wirelessly or via a TCP/IP connection whereby the server (125) may process and record data. In an exemplary embodiment, the server (125) communicates items of interest, as discussed below, to the main radio (150) based at least in part on data received relating to a wearable tag (105). The main radio (150) is operable to communicate items of interest to a wearable tag (105) via a graphics processor (154) associated with the feedback device (135). In another exemplary embodiment, the network bridge (120) may contain a database similar to the server (125) and be operable to communicate items of interest to the main radio (150) based at least in part on data received relating to a wearable tag (105). The network bridge (120) may also be operable to communicate periodically with the server (125) to update messaging relating to items of interest. Still further, the graphics processor (154) may contain memory to store items of interest locally in the control unit (130). Accordingly, the graphics processor (154) may also be operable to communicate periodically with the network bridge (120) via the main radio (150) to update messages for items of interest. By doing so, the amount of time required by the system (100) in order to display items of interest on the feedback device (135) may be further reduced.

Items of interest broadly refer to educational, entertainment (i.e. facebook or social networking), or other like information relevant to a user associated with a wearable tag (105), which may be stored on a database associated with the server (125) or the network bridge (120) and communicated to the user associated with the wearable tag (105) via the feedback device (135). In one embodiment, an authorized user may manually enter items of interest via a touch screen display on the feedback device (135), which is subsequently stored on the database. For example, a healthcare employee may enter information indicating a patient is a fall-risk, a specific requirement relating to bed height angle, or other relevant vital statistics relating to the patient's condition. Upon doing so, the information is stored on the database and displayed to a wearable tag (105) in proximity to or using a monitored device (110) in the patient's room. Items of interest may also be obtained and updated from a plurality of Really Simple Syndication (RSS) feeds, which may contain sports statistics, financial information, or other like information of interest to a user. Accordingly, in another embodiment, a user may select, using the touch screen associated with a feedback device (135), only those RSS feeds which are of interest to the user. In another embodiment, a software application may be delivered to a user's computer, smart phone, PDA, or other device that allows the user to select, configure, and customize the information of interest to be displayed to the user by the feedback device (135) when the wearable tag (105) is in proximity to or using a monitored device (110). Display of items of interest to users encourages and rewards use of the monitored device (110), which is desirable when, for example, the monitored device (110) dispenses hand hygiene products.

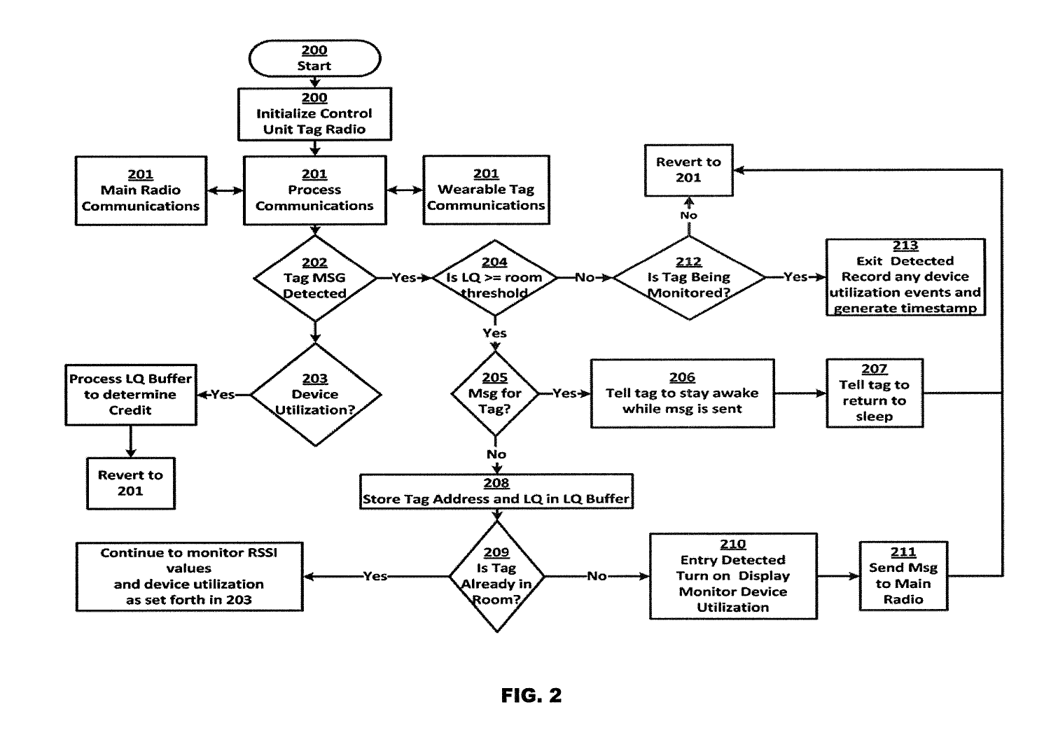

Turning now to FIGS. 1, 1A and 2 in conjunction, a flow chart is shown illustrating the functionality of one embodiment of the tag radio (140). At step (200), the tag radio (140) enters an active state prior to performing any substantive functions. At step (201), the tag radio (140) begins processing wired communications (190) involving the main radio (117) or short range wireless communications (160) involving the wearable tag (105). At step (202), subsequent functions performed by the tag radio (140) become dependent upon the presence or absence of a wearable tag (105) transmitting a short range wireless communication (160). When the patch antenna (144) detects a short range wireless communication (160), the tag radio (140) analyzes the RSSI value and proceeds to step (204). At step (204), subsequent functions performed by the tag radio (140) become a function of the RSSI value in relation to threshold values programmed into the tag radio (140). In an exemplary embodiment, the tag radio (140) may have multiple threshold values for a monitored device (110). As an example, the tag radio (140) may be programmed to have a threshold value for detecting a wearable tag (105) entering/exiting rooms containing a monitored device (110) while another threshold value detects a wearable tag (105) using the monitored device (110). Accordingly, threshold values intended for detecting entry/exit of a wearable tag (105) are lower than threshold values intended for detecting use of the monitored device (110).

In one embodiment, the tag radio (140) may have a threshold value for detecting a hospital employee entering a room containing a hand hygiene dispenser or other like monitored device (110), which may be referred to as a room entry/exit threshold. Still further, the tag radio (140) may further contain a threshold value for detecting use of the hand hygiene dispenser, which may be referred to as a wash threshold value. Accordingly, based upon the RSSI value of a short range wireless communication (160) of a wearable tag (105), the tag radio (140) ascertains whether the RSSI value equals or exceeds any assigned threshold values.

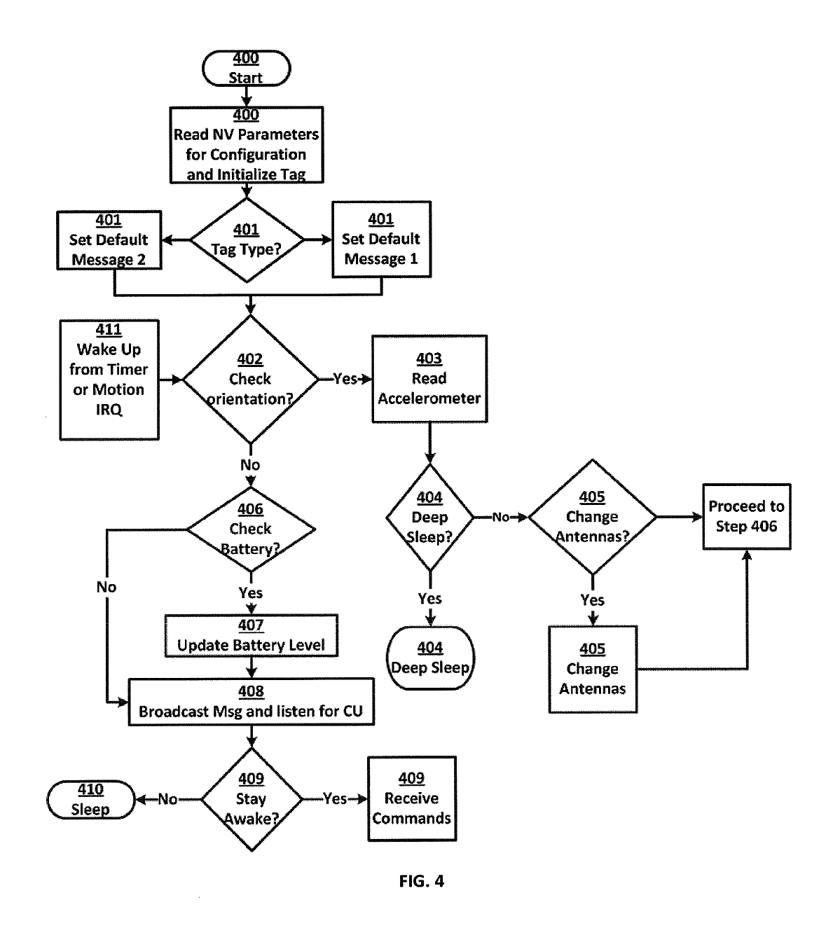

Referring further to FIGS. 1, 1A and 2 in conjunction, if the tag radio (140) determines the RSSI value of a wearable tag (105) equals or exceeds a threshold value for a monitored device (110), then the tag radio (140) performs step (205) to ascertain whether any commands, which are stored locally on the tag radio (150), must be transmitted to the identified wearable tag (105). When a command is transmitted to the identified wearable tag (105), the tag radio (140) performs step (206) and requests the identified wearable tag (105) remain in an active state while commands are sent to the identified wearable tag (105) via a short range wireless communication (160) using the patch antenna (142). In one embodiment, the tag radio (140) may transmit a command to the wearable tag (105) to increase or decrease the frequency with which the wearable tag (105) transmits a signal to the tag radio (140). Once the tag radio (140) finishes transmitting commands to the identified wearable tag (105), the tag radio (140) proceeds to step (207) and requests the wearable tag (105) return to a sleep mode, discussed further in FIG. 4, while the tag radio (140) returns to step (201).

Returning again to step (205), when no messages remain for the wearable tag (105), the tag radio (140) proceeds to step (208) and stores a unique identification code associated with the wearable tag (105) along with its RSSI value in the link quality buffer (144). Then, the tag radio (140) proceeds to step (209) to determine whether the patch antenna (142) previously detected a short range wireless communication (160) involving the wearable tag (105) which equaled or surpassed a threshold value associated with the monitored device (110). If the short range wireless communication (160) represents the first instance of the patch antenna (142) detecting the identified wearable tag (105), then the tag radio (140) shall perform step (210) and records a time stamp indicating the wearable tag (105) entering the room or area in which the monitored device (110) is located. Also occurring at step (210), the tag radio (140) prompts the feedback device (135) associated with the control unit (115) to enter an active state while the patch antenna (142) continues to monitor RSSI values of the wearable tag (105) via subsequent short range wireless communications (160). At step (211), the tag radio (140) communicates data to the main radio (150) via a wired communication (190) relating to at least the unique identification code of the wearable tag (110). Conversely, if the patch antenna (142) previously detected a short range wireless communication (160) from the identified wearable tag (105) while in the room or area in which the monitored device (110) is located, then initial iterations of steps (210) and (211) are not repeated.

If the patch antenna (142) while monitoring RSSI values of a wearable tag (105) begins to detect RSSI values below the lowest threshold value (i.e. room entry/exit threshold) assigned to the tag radio (140), then the tag radio (140) shall proceed to step (212) and determine whether the wearable tag (105) previously communicated an RSSI value that was equal to or exceeded the lowest threshold value. If the tag radio (140) determines the wearable tag (105) was being monitored, (that is, the tag radio (140) previously recorded a time of entry), then the tag radio (140) shall record the wearable tag (105) as having exited the room or area housing the monitored device (110). The tag radio (140) shall also record the occurrence or non-occurrence of device usage by the wearable tag (105) while in the room or area housing the monitored device (110). Conversely, if the RSSI values of a wearable tag (105) are below the lowest threshold value and the wearable tag (105) has not been in the room or area housing the monitored device (110), then the tag radio (140) shall return to step (201). By basing room entry/exit on RSSI values of short range wireless communications (160), the tag radio (140) in conjunction with the patch antenna (142) may distinguish between a wearable tag (105) physically in the room or area housing the monitored device (110) from a wearable tag (105) present in a hallway or other area in proximity to, yet independent from, the room or area housing the monitored device (110).

Returning again to step (202), in the absence of a short range wireless communication (160) originating from a wearable tag (105), the tag radio (140) proceeds to step (203) and monitors usage of the monitored device (110). If the tag radio (140) detects a use of the monitored device (110), then the tag radio (140) processes data stored in the link quality buffer (144) to determine whether credit may be given to a wearable tag (105) having recently communicated with the tag radio (140). However, the tag radio (140) may credit a wearable tag (105) for using a monitored device (110) only in instances where the RSSI value of the wearable tag (105) equaled or exceeded the threshold value for monitoring device usage when the tag radio (140) detected device usage. By imposing this limitation, the tag radio (140) may not falsely credit a wearable tag (105) having previously communicated with the tag radio (140) and in proximity to the monitored device (110) during device usage, yet having an RSSI value outside the range of the threshold value for monitoring device usage. Even in instances where the tag radio (140) is unable to credit a wearable tag (105) for a device usage, the tag radio (140) still communicates the device usage to the main radio (150) via a wired communication (190). By having the tag radio (140) operate in this manner, the server (125) may generate accurate reports accounting for all uses of a monitored device (110).

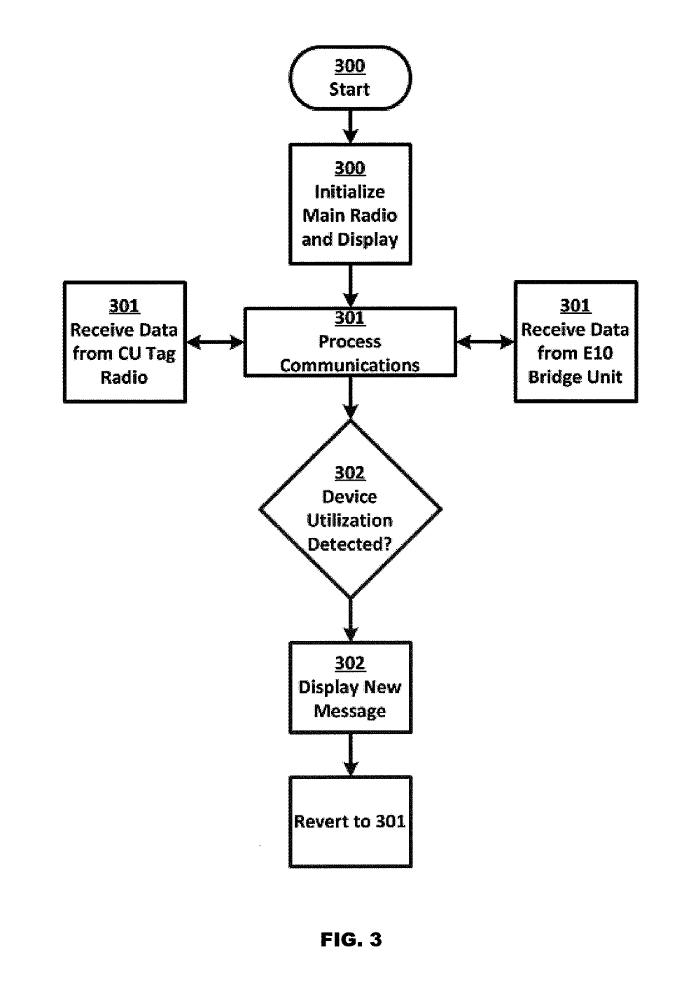

Turning now to FIG. 1, 1A and FIG. 3 in conjunction, a flow chart is shown illustrating the functionality of the main radio (150). As illustrated by step (300), the main radio (150) enters an active state prior to performing substantive functions. At step (301), the main radio (150) begins processing wired communications (190) from the tag radio (140) or long range wireless transmissions (170) over the network. Once the main radio (150) receives a communication from the tag radio (140) indicating a wearable tag (105) using the monitored device (110), the main radio (150) communicates with the network bridge (120) or server (125), as the case may be, to retrieve information relevant to the user or asset associated with the identified tag. Then, the main radio (150) proceeds to step (302) and displays items of interest on a feedback device (135) in proximity to the control unit (115) which are relevant to the wearable tag (105).

Referring now to FIGS. 1 and 4 in conjunction, a flow chart is shown illustrating the functionality of the wearable tag (105). As depicted by step (400), the wearable tag (105) enters an active state prior to performing substantive functions. At step (401), the wearable tag (105) identifies its tag type. Depending on whether the wearable tag (105) represents a personnel tag or an asset tag (e.g. intravenous pump units), the wearable tag (105) selects a default message specific to a personnel or an asset. At step (402), the wearable tag (105) makes a determination as to whether it is time to check its orientation. If the wearable tag (105) does check its orientation, step (403) prompts the wearable tag (105) to obtain a positional reading from an accelerometer housed within the wearable tag (105). Depending on the outcome of step (403), the wearable tag (105) may be prompted to perform step (404) by entering a “deep sleep” mode until the accelerometer detects movement sufficient to “wake up” the wearable tag (105). Otherwise, the wearable tag (105) shall perform step (405) which requires the wearable tag (105) make a determination as to whether its RF antenna communicating with the tag radio (140) must be changed.

As the orientation of the wearable tag (105) changes, (that is, the tag shifts from being worn horizontally to vertically) its RF antenna is changed to increase the accuracy of the RSSI value associated with short range wireless communications (160). Therefore, one RF antenna may be reserved for communicating with the tag radio (140) when the wearable tag (105) is worn horizontally, while a separate RF antenna may be reserved for use when the wearable tag (105) is worn vertically. Accordingly, the wearable tag (105) is programmed to check its orientation at regular intervals (i.e. every sixty seconds) to ensure the proper RF antenna is being used. If a change in RF antennas is not necessary, the wearable tag (105) shall perform step (406) and ascertain whether its battery levels must be checked.

If the wearable tag (105) determines battery levels must be checked, the wearable tag (105) takes a power reading of the battery as mandated by step (407) and updates battery values where applicable. After completing step (407), the wearable tag (105) may proceed to step (408) and transmit a short range wireless communication (160) to the tag radio (140) and listen for any messages from the tag radio (140) requesting the wearable tag (105) remain in an active state. At step (409), the wearable tag (105) may remain in an active state while receiving messages from the tag radio (105) and subsequently enter a “sleep mode” as depicted in step (410). The wearable tag (105) may then remain in “sleep mode” until the lapse of a predetermined amount of time as mandated by step (411) prompting the wearable tag (105) to perform a subsequent iteration of steps (402) through (410).

It will be appreciated by those skilled in the art having the benefit of this disclosure that this method and apparatus for improving upon a system for detecting device utilization provides for an improved system for monitoring device utilization. Furthermore, it should be understood that the drawings and detailed description herein are to be regarded in an illustrative rather than a restrictive manner, and are not intended to be limiting to the particular forms and examples disclosed.

What is claimed is:

1. An apparatus comprising:
a control unit associated with a monitored device, the control unit comprising a tag radio and a main radio, the tag radio comprising a first antenna operable to detect and communicate with a wearable tag associated with an asset over a first channel, the main radio comprising a second antenna operable to communicate data over a communications network over a second channel, wherein the control unit is operable to communicate simultaneously with a wearable tag and with a communications network.

2. The apparatus of claim 1, wherein the monitored device is a hand hygiene dispenser.

3. The apparatus of claim 2, wherein the first antenna is a directional, short-range antenna, and the second antenna is an omnidirectional, long-range antenna.

4. The apparatus of claim 3, wherein the tag radio is operable to detect short-range communications over the first channel originating from a wearable tag associated with a person, said short-range communications comprising at least an identification code and a Radio Signal Strength Identification (RSSI) value associated with the wearable tag.

5. The apparatus of claim 4, wherein the tag radio is operable to determine activity of the person based upon the RSSI value.

6. The apparatus of claim 5, wherein activity is selected from the group consisting of: entry or exit of a physical area in which a monitored device is located; and proximately to a monitored device.

7. The apparatus of claim 4, wherein the tag radio is operable to monitor signals indicating use of monitored device and record such use.

8. The apparatus of claim 7, wherein the tag radio is operable to record use of a monitored device by a wearable tag associated with a person if, upon receiving said signal, the tag radio detects an RSSI value associated with the tag that is equal to or greater than a predetermined value.

9. The apparatus of claim 8, wherein the tag radio is operable to communicate at least an identification code associated with the wearable tag to the main radio for communication to a server over the network.

10. The apparatus of claim 9, wherein the control unit is operable to display items of interest on a feedback device associated with the control unit received from the server in response to the identification code.

11. In a hand hygiene compliance system in which monitored assets comprise identifying tags capable of radio frequency communications and in which data relating to monitored assets is communicated over a communications network to a server, a method comprising:
monitoring a first channel with a tag radio to monitor actions of a monitored asset associated with a tag;
simultaneously maintaining a communications link over a second channel between a main radio and the communications network; and
communicating data regarding the monitored asset from the tag radio to the main radio for communication to the network.

12. The method of claim 11, wherein the monitoring step is performed with a directional antenna associated with the tag radio.

13. The method of claim 12, wherein the tag radio operates at a lower power than the main radio.

14. The method of claim 12, wherein the monitoring step further comprises detecting short-range communications originating from a tag, said short-range communications comprising at least an identification code and a Radio Signal Strength Identification (RSSI) value associated with the tag.

15. The method of claim 14, wherein the monitoring step further comprises determining activity of a monitored asset based upon the RSSI value.

16. The method of claim 15, further comprising generating with the tag radio, a timestamp associated with activity of the monitored asset.

17. The method of claim 15, wherein said activity is selected from the group consisting of: entry or exit of a physical area in which a monitored device is located; and proximately to a monitored device.

18. A system comprising
a wearable tag associated with an asset, the wearable tag operable to communicate over a first channel via radio frequency (RF); and
a control unit associated with a monitored device, the control unit comprising a tag radio and a main radio, the tag radio comprising a first antenna operable to detect and communicate with the wearable tag over the first channel, the main radio comprising a second antenna operable to communicate data over a communications network over a second channel, wherein the control unit is operable to communicate simultaneously with the wearable tag and the communications network

19. The system of claim 18, wherein the wearable tag is operable to transmit short-range communications over the first channel at predetermined time intervals.

20. The system of claim 18, wherein the wearable tag further includes an accelerometer and is operable to transmit short-range communications over the first channel each time the accelerometer detects movement.

21. The system of claim 18, wherein the wearable tag further includes two RF antennas and is operable to select one of the two RF antennas to transmit short-range communications over the first channel based upon orientation of the wearable tag.
